(19) United States
(12) Patent Application Publication
(10) Pub. No.: US 2010/0167576 A1
(43) Pub. Date: Jul. 1, 2010

(54) REPLACEABLE LAMP ASSEMBLY

(76) Inventor: Nan-Qing Zhou, Fujian (CN)

Correspondence Address: Banger Shia, 204 Canyon Creek, Victoria, TX, 77901, US

(21) Appl. No.: 12/600,658

(22) PCT Filed: Dec. 26, 2007
(86) PCT No.: PCT/CN07/71324

§ 371 Date: Nov. 17, 2009

(30) Foreign Application Priority Data
May 30, 2007 (CN) 200720007251.8

(51) Int. Cl. H01R 13/64

(52) U.S. Cl. 439/375

(57) ABSTRACT

A replaceable lamp assembly includes a lamp adapter and a lamp holder. The lamp adapter is detachably connected to the lamp holder. The lamp adapter has a top provided with a connecting member and a bottom formed with a sliding trough. The lamp holder has a top provided with a sliding block which corresponds to the sliding trough. The sliding trough and the sliding block are either a T-shaped trough and a T-shaped block or a swallow-tailed trough and a swallow-tailed block, which have a flat configuration without taking a lot of space. Accordingly, the lamp adapter has enough space to accommodate a circuit board, a lamp ballast, and so on. It is not necessary to increase the size of the lamp adapter. The lamp assembly of the present invention is compact and changeable in shape.

### BACKGROUND OF THE INVENTION

1. Field of the Invention

The present invention relates to a lighting device, and more particularly to a replaceable lamp assembly.

2. Description of the Prior Art

Most compact fluorescent lamps have a replaceable structure which is disposed between a connecting member and a lamp adapter as well as between the lamp adapter and a lamp holder, such that the user can replace a connecting member in a different size or shape as well as a lamp tube in a different shape. When one part of the lamp is damaged, only the damaged part is replaced so as to save cost. For the lamp manufacturers, they can standardize each part of the lamp. When developing a new product, the lamp manufacturer only needs a new mold for the changed part. This way can reduce the manufacture cost very much.

The applicant filed a Chinese patent application number 20072000644.8 on Feb. 27, 2007, titled “a replaceable compact fluorescent lamp”. As shown in FIG. 1, a compact fluorescent lamp 1 has a detachable structure between the connecting member and the lamp adapter as well as between the lamp adapter and the lamp holder. However, its connecting structure has some shortcomings. The bottom of the lamp adapter 2′ is formed with a recess 23′ and the top of the lamp holder 3′ is provided with a protruding post 31′ to be inserted in the recess 23′. There is an engaging structure between the protruding post 31′ and the recess 23′. In order to achieve a reliable connection of the aforesaid connecting structure, the size of the protruding post 31′ must be large, and the engaging structure between the protruding post 31′ and the recess 23′ is essential. The size of the recess 23′ must correspond to that of the protruding post 31′, such that the recess 23′ takes a lot of inner space of the lamp adapter 2′. However, the lamp adapter 2′ still needs the space for accommodating a circuit board, a lamp ballast, and so on. For this reason, the size of the lamp adapter 2′ is unable to be compact, so that the shape and style of the lamp is limited.

### SUMMARY OF THE INVENTION

The primary object of the present invention is to provide a replaceable lamp assembly which comprises a lamp adapter and a lamp holder. The connecting structure between the lamp adapter and the lamp holder is detachable, simple and reliable so that the lamp assembly is compact.

According to the present invention, there is provided a replaceable lamp assembly which comprises a lamp adapter and a lamp holder. The lamp adapter is detachably connected to the lamp holder. The lamp adapter has a top provided with a connecting member and a bottom formed with a sliding trough. The lamp holder has a top provided with a sliding block which corresponds to the sliding trough.

Preferably, the sliding trough is a T-shaped trough and the sliding block is a T-shaped block.

Alternatively, the sliding trough is a swallow-tailed trough and the sliding block is a swallow-tailed block.

Preferably, one side of the sliding trough is provided with two conductive sheets, and one side of the sliding block is provided with conductive members corresponding to the conductive sheets.

Preferably, the conductive sheets have concave points thereon, and the conductive members have convex points thereon.

Preferably, the sliding trough and the sliding block have corresponding surfaces provided with engaging configurations.

Preferably, the connecting member is detachably connected to the lamp adapter. The top of the lamp adapter is provided with a protruding platform. The protruding platform is screwed or engaged with the connecting member. The protruding platform includes an electric conductor disposed on the center of a top surface thereof and a resilient conductive plate disposed on a side wall thereof. The connecting member is made of conductive material.

By the sliding trough and the sliding block, the lamp adapter and the lamp holder of the present invention are connected together. The sliding trough and the sliding block are either a T-shaped trough and a T-shaped block or a swallow-tailed trough and a swallow-tailed block, which have a flat configuration without taking a lot of space. Accordingly, the lamp adapter has enough space to accommodate a circuit board, a lamp ballast, and the like therein. It is not necessary to increase the size of the lamp adapter. The lamp assembly of the present invention is compact and changeable in shape. Besides, compared to the existing products, the connecting structure between the lamp adapter and the lamp holder is simple and reliable.

### BRIEF DESCRIPTION OF THE DRAWINGS

FIG. 1 is an exploded view of a conventional replaceable compact fluorescent lamp;

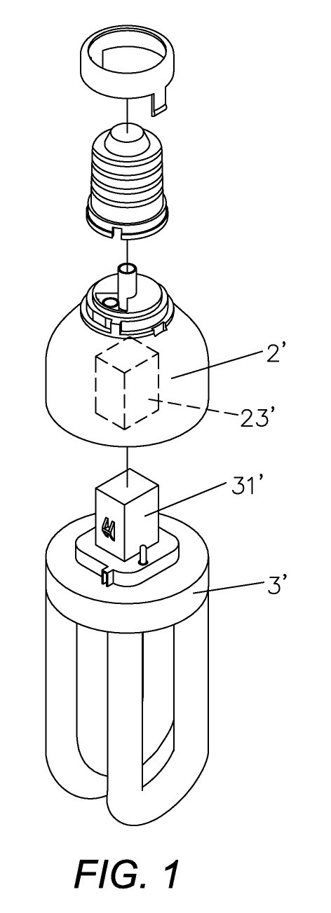

FIG. 2 is an exploded view of the present invention;

FIG. 3 is a perspective view of the present invention;

FIG. 4 is a cross-sectional view of the present invention; and

FIG. 5 is an exploded view showing a connecting member and a lamp adapter of the present invention.

### DETAILED DESCRIPTION OF THE PREFERRED EMBODIMENTS

Embodiments of the present invention will now be described, by way of example only, with reference to the accompanying drawings.

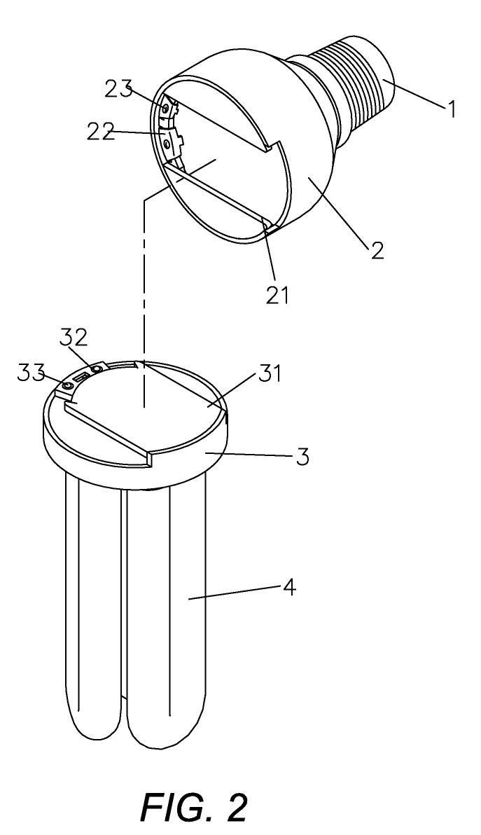

As shown in FIG. 2, a replaceable lamp assembly of the present invention comprises a lamp adapter 2 and a lamp holder 3. The lamp adapter 2 is detachably connected to the lamp holder 3.

The lamp adapter 2 has a top provided with a connecting member 1. The connecting member 1 can be fixedly or detachably connected to the lamp adapter 2. The lamp adapter 2 has a bottom formed with a sliding trough 21. One side of the sliding trough 21 is provided with two conductive sheets 22. The conductive sheets 22 have concave points 23 thereon.

The lamp holder 3 has a bottom connected with a lamp tube 4 and a top provided with a sliding block 31 which corresponds to the sliding trough 21. One side of the sliding block 31 is provided with conductive members 32 corresponding to the conductive sheets 22. The conductive members 32 have convex points 33 thereon.

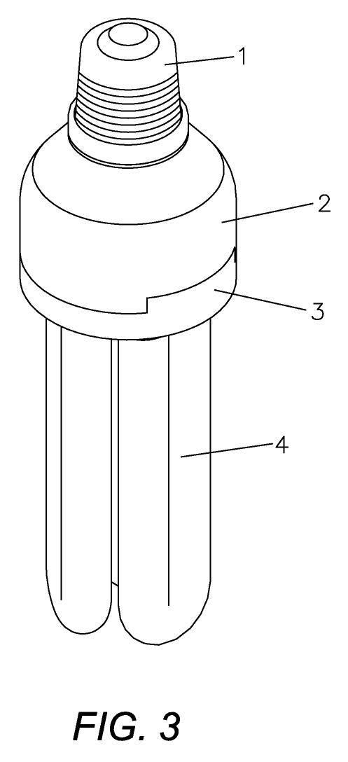

FIG. 3 shows the assembly of the present invention. The sliding trough 21 of the lamp adapter 2 is slidably connected to the sliding block 31 of the lamp holder 3, while the conductive sheets 22 are contact with the conductive members 32 and the convex points 33 of the conductive members 32 are engaged with the concave points 23 of the conductive sheets 22. The engagement of the convex pints 33 and the concave points 23 is to ensure electric connection and provides a positioning effect so as to prevent the disengagement of the sliding trough 21 and the sliding block 31.

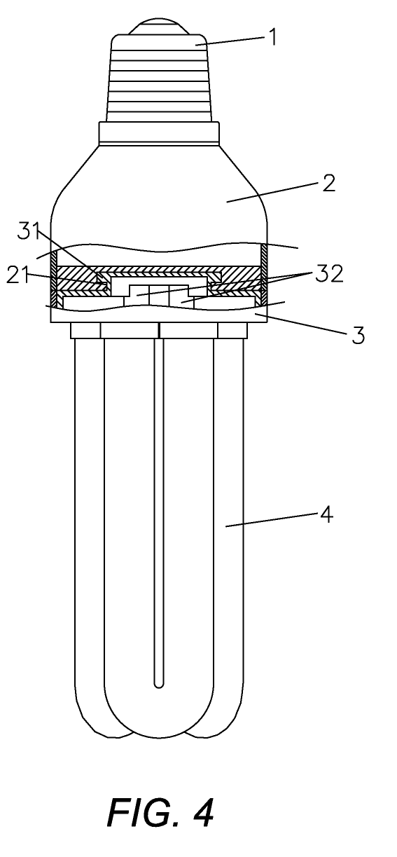

The sliding trough 21 and the sliding block 31 can be a T-shaped trough and a T-shaped block, respectively. As shown in FIG. 4, the sliding trough 21 and the sliding block 31 can be a swallow-tailed trough and a swallow-tailed block, respectively. The concave points 23 and the convex points 33 are adapted to position the lamp adapter 2 and the lamp holder 3, preventing them from disengagement. The concave points 23 and the convex points 33 can be disposed on corresponding surfaces of the sliding trough 21 and the sliding block 31, and can be other engaging configurations.

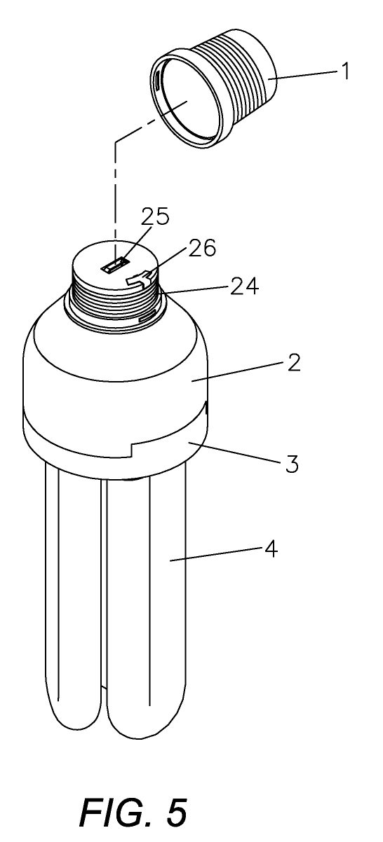

As shown in FIG. 5, the connecting member 1 can be detachably connected to the lamp adapter 2. The top of the lamp adapter 2 is provided with a protruding platform 24. The protruding platform 24 is screwed or engaged with the connecting member 1. The protruding platform 24 includes an electric conductor 25 disposed on the center of a top surface thereof and a resilient conductive plate 26 disposed on a side wall thereof. The connecting member 1 is made of conductive material. When the connecting member 1 is screwed or engaged with the protruding platform 24 of the lamp adapter 2, the electric conductor 25 on the top of the lamp adapter 2 is contact with a conductive post (not shown in the drawings) provided at the center of the connecting member 1 and the resilient conductive plate 26 on the side wall of the protruding platform 24 of the lamp adapter 2 is contact with an inner wall of the connecting member 1 so as to achieve electric connection.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A replaceable lamp assembly, comprising a lamp adapter and a lamp holder, the lamp adapter being detachably connected to the lamp holder, the lamp adapter having a top provided with a connecting member and a bottom formed with a sliding trough, the lamp holder having a top provided with a sliding block which corresponds to the sliding trough.

2. The replaceable lamp assembly as claimed in claim 1, wherein the sliding trough is a T-shaped trough and the sliding block is a T-shaped block.

3. The replaceable lamp assembly as claimed in claim 1, wherein the sliding trough is a swallow-tailed trough and the sliding block is a swallow-tailed block.

4. The replaceable lamp assembly as claimed in claim 1, 2 or 3, wherein one side of the sliding trough is provided with two conductive sheets, and one side of the sliding block is provided with conductive members corresponding to the conductive sheets.

5. The replaceable lamp assembly as claimed in claim 4, wherein the conductive sheets have concave points thereon, and the conductive members have convex points thereon.

6. The replaceable lamp assembly as claimed in claim 1, wherein the sliding trough and the sliding block have corresponding surfaces provided with engaging configurations.

7. The replaceable lamp assembly as claimed in claim 1, wherein the connecting member is detachably connected to the lamp adapter, the top of the lamp adapter being provided with a protruding platform, the protruding platform being screwed or engaged with the connecting member, the protruding platform including an electric conductor disposed on the center of a top surface thereof and a resilient conductive plate disposed on a side wall thereof, the connecting member being made of conductive material.
